(19) United States
(12) Patent Application Publication
(10) Pub. No.: US 2003/0029542 A1
(43) Pub. Date: Feb. 13, 2003

(54) Appartatus and method for dispensing tape and compound

(76) Inventor: Daniel Dea Dillinger, Parsons, KS (US)

Correspondence Address: James E. Bradley, BRACEWELL & PATTERSON, LLP, P.O. Box 61389, Houston, TX, 77208-1389, US

(21) Appl. No.: 09/925,994

(22) Filed: Aug. 9, 2001

(51) Int. Cl. B32B 31/00

(52) U.S. Cl. 156/71; 156/350; 156/361; 156/368; 156/574; 156/575

(57) ABSTRACT

A tape and compound dispenser for wall surfaces automatically matches the delivery of the compound to the feed of the tape. The system has a compartment or tank that contains compound. A pump supplies compound from the tank through a flexible conduit to an applicator, which dispenses tape and compound. A sensor measures the rate of speed of the tape as it is being dispensed and provides a signal to a controller. The controller will vary the flow rate by varying the speed of the motor that drives the pump. An auger is rotated within the tank for prefeeding compound to the pump as well as for mixing compound.

### BACKGROUND OF THE INVENTION

1. Technical Field

The present invention relates in general to improved wall surface finishing, and in particular to an integrated system and method for automatically applying tape and joint compound to drywall joints.

2. Description of the Prior Art

Wallboard or drywall has become the dominant material in the production of interior building partitions. Interior building partitions typically comprise a studwall of vertical support members or studs that are spaced apart from each other in a parallel arrangement. The studs are used to support preformed panels or wallboards that are usually attached to the studwall with fasteners. A joint exists between adjacent ones of the abutted wallboards.

In order to provide a continuous flat surface appearance to the wall, it is necessary to apply a finish to the joint between the adjacent panels. Finishing typically requires the build-up of multiple layers of a mastic material or joint compound that is commonly referred to as mud. Mud is a pastelike substance that is formed by mixing a powdery compound with water. The blending of the joint compound into the panel surface forms the desired flat and contiguous wall surface. The build-up of mud in the joint area or “floating” comprises the application of a first layer of mud and the embedding of a wallboard tape such as paper or fiberglass tape in the first layer. Finally, one or two more layers of mud are applied on top of the first layer/tape to complete the joint. The finishing of the joints is a time consuming and labor intensive process.

It is convenient to use a container for the mud which may or may not include means for supporting a roll of tape. Combination mud and tape devices guide the tape through the mud and dispense it from the container at the desired length with the tape coated in the mud. A number of devices have been proposed in attempts to more efficiently and effectively dispense mud during the process. Some devices are pressurized to dispense the mud, while others require traditional manual application. Most prior art designs have not been fully accepted by the construction trade. In particular, air pressurized systems have been marginal at best as there is significant time lag during dispensing, and a potentially uneven application. Although the systems of the prior art may be manually adjusted to vary the mud flow rate, this is difficult to accomplish because the rate at which the worker applies the tape varies.

One type of prior art tool that is in commercial use has an elongated body that is filled with compound. A roll of tape is mounted to the body and leads to the head of the tool A star wheel, mounted to the head, presses the tape against the wall. As the worker moves the head and applies pressure to the body, the paper will feed from the roll. The star wheel drives a sprocket and spindle via a chain. A cable is wrapped around the spindle and leads to a piston located in the body. The movement of the head along the wall surface causes the piston to move forward, pushing compound from the head. This unit also has a blade that is drawn across the tape to cut the tape at the end of a stroke. The blade is reciprocated by an external sleeve mounted to the body. The unit also has a kickout wheel that has a sharp edge for folding and pressing tape into corners. A cable leads from the kickout wheel back to a lever near the rearward end of the stroke. Once all of the compound is depleted from the tool, the operator disengages the piston from the cable, and the piston is returned to the rearward end as the body is refilled with compound.

### 3. SUMMARY OF THE INVENTION

In this invention, a compartment or tank is utilized that contains compound for mud. A pressure source, such as a pump, is in communication with of the outlet of the tank. A conduit leads from the pressure source to an applicator that contains a quantity of tape. The applicator has a sensor that senses the rate of movement of the tape while the operator moves the head of the applicator along the wall surface. The tape speed sensor provides a signal to a controller, which in turn controls the pressure source.

As the tape feeds from the applicator onto the wall board, the tape sensor senses the rate of tape feed and signals the controller to cause the pressure source to flow compound through the conduit and out the applicator. The controller continuously monitors the tape speed signal and varies the rate of compound flowing from the applicator.

Preferably, the controller controls the output of compound by varying the speed of the pump. The controller automatically stops flow of the compound if movement of the tape ceases, preferably by turning off the pump. The controller preferably varies the speed of the pump linearly relative to the speed of the tape movement. An exception to the linear relationship occurs when the tape first starts to move. A booster circuit in the controller will then cause the pump to operate at a higher rate of speed than normally occurring on the linear slope. This higher rate of speed occurs only for a short duration. This causes the hose to instantly pressurize so that all further control is linear to the movement of the tool and tape. When shutting off the pump due to cessation of movement of the tape, preferably the controller will rotate the pump rotor an increment of a turn in the reverse direction to alleviate pressure at the outlet of the pump.

In the preferred embodiment, an auger is located in the compartment for mixing the compound as well as assisting in causing the compound to flow from the compartment to the pump. The auger is configured so that when rotating in a forward direction, it induces flow toward the outlet, and while operated in a rearward direction, it tends to push compound away from the outlet.

The applicator may be of various types. The applicator shown in the preferred embodiment has an elongated tubular body for the flow of compound to the head. In the preferred embodiment, the tape sensor includes a rotary member on the head that rotates due to movement of the tape. A cable is turned by the rotary member, the cable leading to a sensor that is mounted a selected distance from the head. The sensor senses the rotational movement of the cable and provides a signal in proportion to the rate of rotation. The position of the sensor is such that it will normally be far enough from the head so as to avoid being submerged in water during cleaning operations.

In this embodiment, the applicator has a kickout wheel that is pivotally mounted to the head for applying a crease to the tape while applying the tape to corners. The kickout wheel is actuated by a manually operable lever that is pivotally mounted to the body of the applicator. The kickout wheel cable extends along the applicator to a link, which is pivotally mounted to the body. The link and lever are operationally coupled by rotary members, which are cooperatively engaged so that rotation of one of the shafts in one direction rotates the other in the opposite direction. One of the rotary members is larger in diameter than the other to multiply the amount of stroke of the lever. Pulling the lever toward the proximal end of the applicator causes the kickout wheel move from the storage to the operation position.

### 4. BRIEF DESCRIPTION OF THE DRAWINGS

FIG. 1 is a schematic view illustrating an apparatus constructed in accordance with this invention.

FIG. 2 is a flow chart illustrating the operation of the controller of the apparatus of FIG. 1.

FIG. 3 is a block diagram illustrating the controller of the apparatus FIG. 1.

FIGS. 4a and 4b comprise a side view of an applicator for the apparatus of FIG. 1.

FIGS. 5a and 5b are views of the opposite side of the applicator of FIGS. 4a and 4b.

FIG. 6 is a partially broken away view of an actuating lever for the kickout wheel of the applicator of FIGS. 4 and 5.

### 5. DETAILED DESCRIPTION OF THE INVENTION

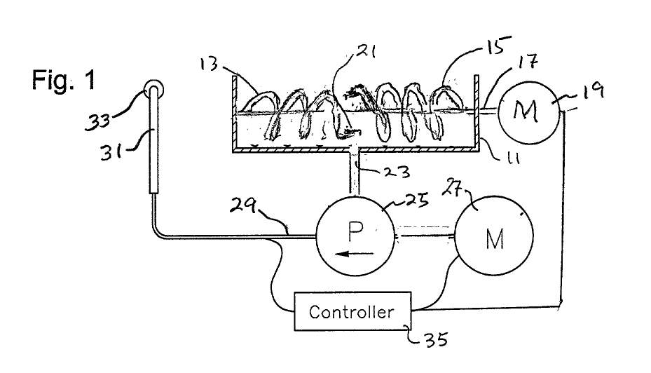

Referring to FIG. 1, the apparatus of this invention includes a tank or compartment 11. Compartment 11 is preferably mounted on wheels and designed to hold wall finishing material, particularly joint compound. Compartment 11 has two parallel ends and a lower portion that is generally cylindrical. A pair of augers 13, 15 extend between the ends within the lower cylindrical portion of compartment 11. Augers 13 and 15 are rotated by the same shaft 17 but are configured opposite each other so that they move compound in opposite directions. Augers 13, 15 preferably have a central opening between each blade portion and shaft 17. The outer peripheries of augers 13, 15 define a cylindrical surface of revolution when rotated by shaft 17. The inner peripheries of the blades of augers 13, 15 may have undulations or serrations to facilitate mixing.

An electrical auger motor 19, preferably a constant speed AC motor, rotates shaft 17 in forward and reverse directions. When motor 19 rotates in a reverse direction, augers 13, 15 push material from a central area toward the opposite ends. When rotated in a forward direction, augers 13, 15 push material from the opposite ends toward the central area. Preferably, a plate 21 is mounted to each of the centrally located ends of each auger 13, 15. Plates 21, when rotated, will pass closely over a centrally located outlet 23. The proximity of each plate 21 as it passes over outlet 23 forces compound from compartment 11 down outlet 23.

The reverse direction is employed for mixing of compound. Dual safety switches (not shown) are mounted to compartment 11. If the lid (not shown) to compartment 11 is open, both switches must be manually pushed and held by an operator to cause augers 13, 15 to rotate in either the reverse or the forward directions.

A pressure source 25 has an inlet in communication with outlet 23. Pressure source 25 is preferably a positive displacement pump such as a progressive cavity pump having an elastomeric stator with helical cavities and a helical rotor. Pump 25 is driven by a variable speed DC electrical motor 27 in the preferred embodiment. Varying the speed of motor 27 causes the output or flow rate of pump 25 to vary. While a variable speed progressive cavity pump is preferred, a variable displacement constant speed pump is also feasible.

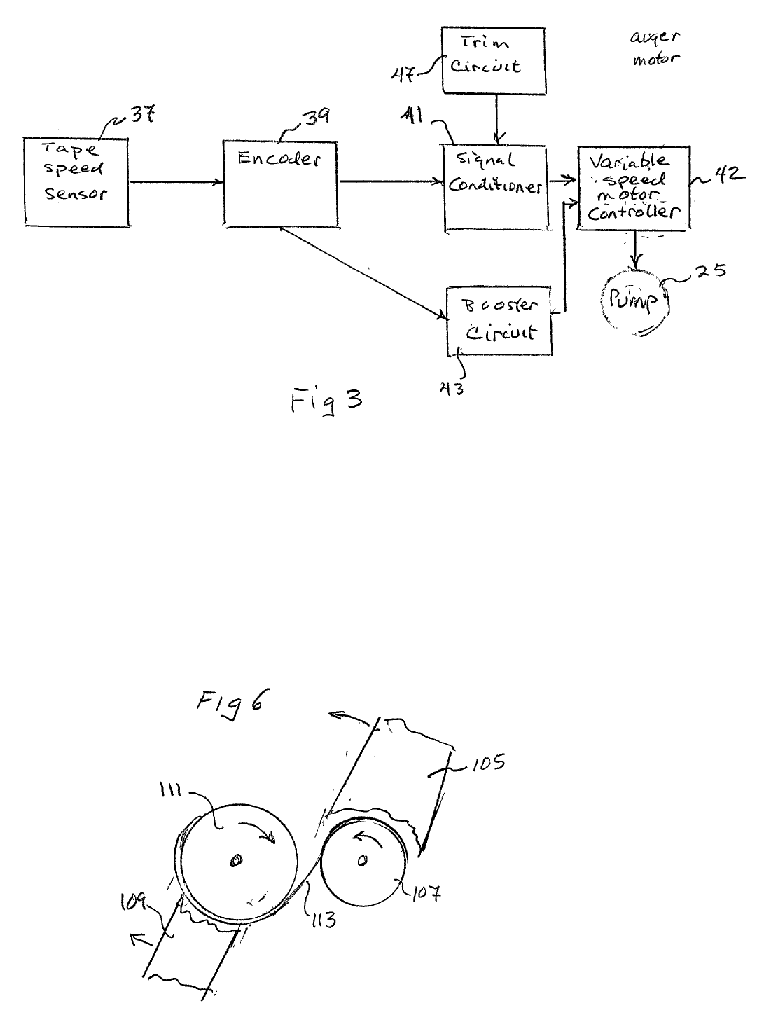

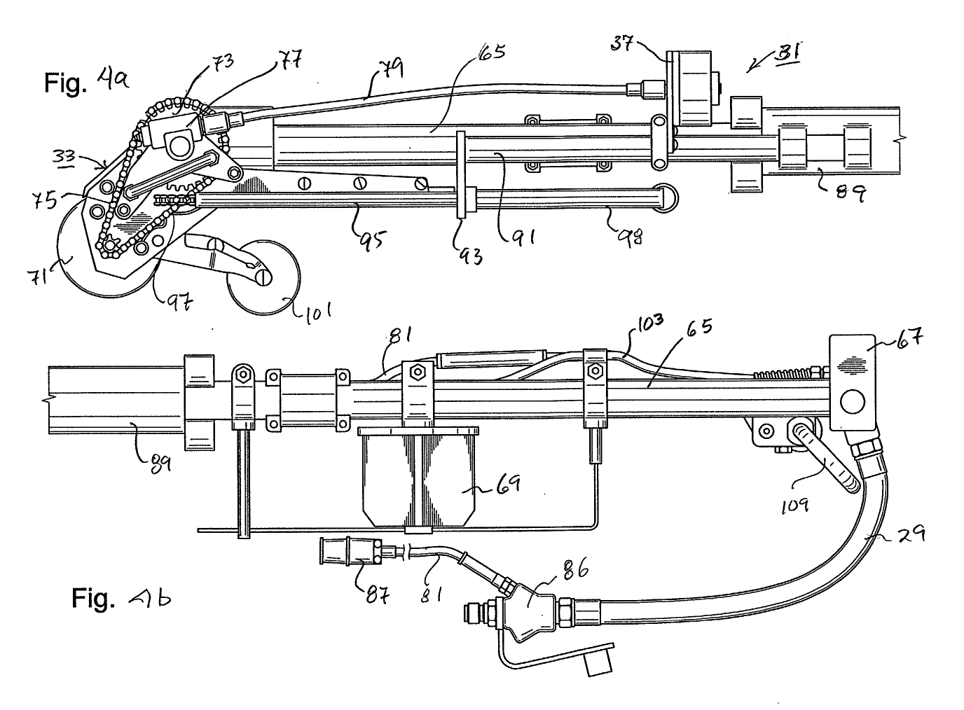

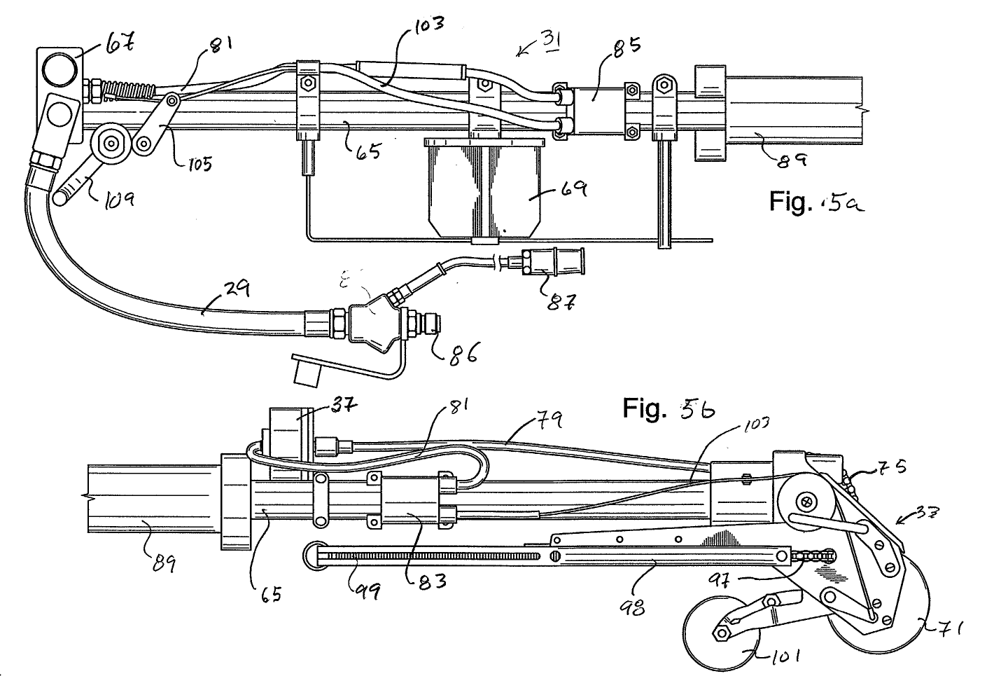

Pump 25 has its output coupled to a flexible hose or conduit 29. Conduit 29 leads to an applicator 31 including an applicator head 33. Applicator 31 is held by a worker, who places the head 33 of applicator 31 in contact with the wall and moves it along the wall to dispense tape and compound. There are a variety of feasible applicators. One type of applicator (shown in FIGS. 4 and 5) uses a roller or wheel that frictionally engages the wallboard, pulls the tape from a storage roll and simultaneously dispenses compound. Another type of applicator has a flat blade, with the friction of the blade pressing against the tape and the wallboard causing the tape to adhere to the wall and feed from the applicator as the worker moves the blade along the wall.

An electrical controller 35 is connected to applicator 31 and motors 19 and 27. Controller 35 controls the output of pump 25 by controlling the speed of motor 27 in a conventional manner. Controller 35 varies the speed by varying the level of DC voltage supplied to motor 27. Alternately, an AC motor could be utilized with a conventional electrical variable speed drive varying the motor speed by varying the frequency of the voltage supplied to motor 27.

Controller 35 controls the speed of motor 27 in response to the rate at which the tape is being dispensed from the applicator 31. The rate at which tape is dispensed from applicator 31 depends upon the speed at which the worker moves the head 33 across the wall surface. Referring to FIG. 3, a tape speed sensor 37 that is mounted to applicator 31 senses the speed of movement of the tape as it is dispensed. Tape speed sensor 37 communicates the information to an encoder 39, which may be incorporated as part of tape sensor 37. Encoder 39 provides a digital signal to a signal conditioner 41. Signal conditioner 41 is preferably a conventional circuit that provides a DC output voltage that is proportional to the signal being received. Signal conditioner 41 provides the output voltage to a variable speed drive or motor controller 42 of pump motor 27, which varies the speed accordingly. Preferably, the relationship is linear between the speed of movement of the tape and the speed of pump motor 27, although a nonlinear response is also feasible.

Signal conditioner 41 has a slight time lag between receiving a signal from encoder 39 and providing an output voltage to motor controller 42 of pump motor 27. A booster circuit 43 is employed to avoid the tape dispensing a few inches at start up before the compound begins to flow from applicator 31. Booster circuit 43 reduces any skipping or lag at the initiation of the stroke by instantly pressurizing the hose. In this embodiment, booster circuit 43 is a microprocessor-based circuit that incorporates a clock and receives the same signal from encoder 39 that signal conditioner 41 receives. If movement of applicator head 33 ceases, then starts again, booster circuit 43 provides an output voltage to motor controller 42 of pump 27 that causes pump 27 to operate preferably at its maximum rate for a short period of time. The pulses from the encoder 39 must be of a selected minimum rate, for example 14 hertz, in order for booster circuit 43 to provide a timed output voltage to motor controller 42 of pump motor 27. To avoid a minor bump actuating booster circuit 43, preferably there must be a selected number of consecutive pulses from encoder 39, such as three consecutive pulses at or above 14 hz. Other frequencies and numbers of pulses are also possible.

The timed output voltage overrides the voltage being supplied from signal conditioner 41. This timed output causes pump motor 27 to operate at a much higher rate of speed than it would otherwise be operating if receiving only a voltage from signal conditioner 41. The increased voltage from booster circuit 43 is only for a certain time period and will not initiate again until the signals or pulses from encoder 39 cease for a selected time. Signal conditioner 41 continues to supply voltage to motor controller 42 of pump motor 27 while booster circuit 43 is operating. Thus at the end of the output voltage from booster circuit 43, signal conditioner 41 will take over and continue driving pump motor 27 through motor controller 42. In the preferred embodiment, booster circuit 43 is adjustable to provide an output voltage from 0 to 10 volts when receiving a signal from encoder 39 in the range from 8-14 hertz. The timed duration of the output voltage from booster circuit 43 is adjustable, preferably in the range from 0.1 to 1.6 seconds. As long as the encoder 39 is producing a pulse of a small frequency, booster circuit 43 will not initiate another output voltage to pump 27. When movement of head 33 ceases, the pulses from encoder 39 to booster circuit 43 cease, allowing booster circuit 43 to reset so that upon restarting movement of head 33, booster circuit 43 will again provide a timed output voltage. Preferably about 1.5 second time duration is required between receiving no pulses and the reset of booster circuit 43. The settings for booster circuit 43 may be other than as mentioned above for the preferred embodiment.

To compensate for differences in the viscosity of compound or mud, a compound trim circuit 47 is connected to signal conditioner 41 to give the operator the ability to change the pump 27 flow rate for a given tape speed. Trim circuit 47 reduces or increases the output voltage of signal conditioner 41 for the same frequency input from encoder 39. The relationship between encoder 39 and signal conditioner 41 remains linear, but the slope will change. Trim circuit 47 preferably is able to vary the output voltage and thus the speed of pump 27 by as much as twenty percent or more. The functions of trim circuit 47 may also be handled by software, rather than a dedicated circuit.

While the circuitry described above involves separate circuits, a microprocessor based circuit that combines all of the control functions mentioned above into one solid state device is also feasible. Any combination of frequency and control voltage or amperage is possible. In one embodiment, encoder 39 generates a maximum speed of 555 hertz, resulting in an output voltage from signal conditioner 41 of 10 volts. This produces 3,000 RPM on pump motor 27, which produces 1.67 gallons per minute of compound from one type of pump 25. At this rate, a taping speed of about 3.15 feet per second can be achieved, based upon a compound thickness under the tape of 0.08 inches. Each 0.01 decrease in mud thickness adds approximately 0.4 feet per second to the taping speed. Trim circuit 47 becomes a valuable contribution to the system by allowing the user to trim the compound flow rate to an exact needed quantity so as to maximize the top operational speed of the system.

Controller 35 causes motor 27 for pump 25 to rotate an increment in reverse each time power to motor 27 ceases. Reversing the rotation of pump 25 causes material to flow in an opposite direction. By reversing pump 25, compound is subtracted from the head of pump 25, creating zero pressure at the outlet. With no pressure at the head of pump 27, there will be substantially no pressure against the compound at the applicator head 33. The reverse cycle is preferably initiated by a current sensor. The current sensor activates a timing circuit when current is present at the pump motor 27 and completes when the current goes to zero. The reverse cycle can be interrupted at any time while the reverse cycle is underway. This reduces any possibility that an operator will have his production limited by the reverse cycle.

Controller 35 controls motor 19 for augers 13, 15 as well as pump motor 27. For premixing of compound, the operator may rotate augers 13, 15 in reverse. Dual safety switches (not shown) are mounted to compartment 11. If the lid (not shown) to compartment 11 is open, both switches must be manually pushed and held to cause augers 13, 15 to rotate in either the reverse or the forward directions. The reverse direction mixing will inhibit the action of pump 23. In the forward run position, one of two modes of operation for augers 13, 15 may be selected. The first mode is a continuous run mode that continues rotating augers 13, 15 in the forward direction as long as the lid of compartment 11 is closed. Even if pump 25 is stopped, augers 13, 15 will continue to rotate while in the continuous mode. In the intermittent mode, augers 13, 15 are rotated only when pump 25 is rotating. The intermittent mode prevents over-mixing of compound.

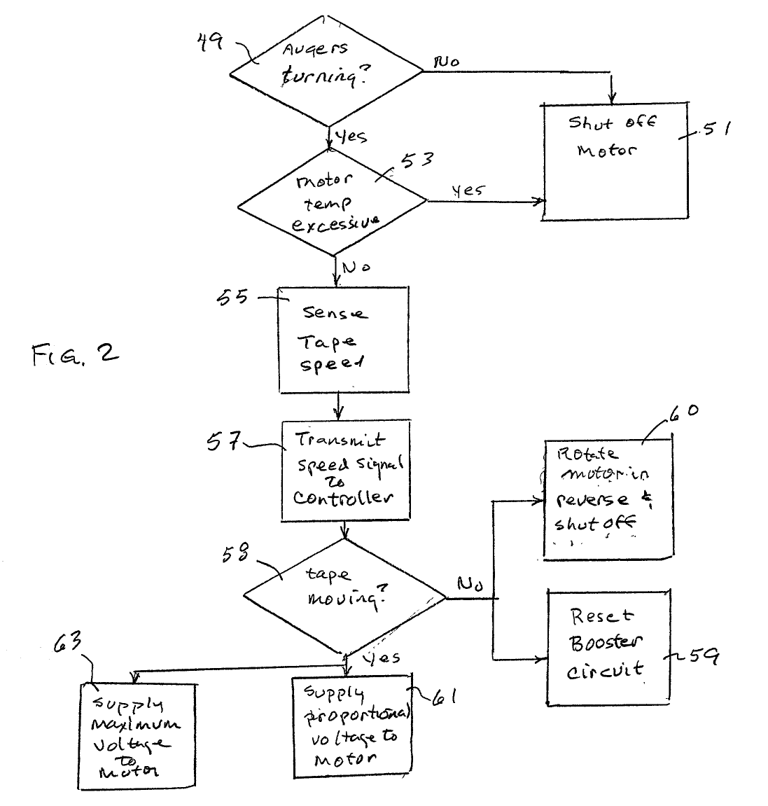

The flow chart of FIG. 2 illustrates the overall operation of the system. Prior to commencing the logic as depicted in FIG. 2, the controller 35 upon initiation provides a control signal to the motor 19, which activates augers 13,15 so that the pump 25 is provided with compound at the start of the logic sequence. Step 49 verifies this by inquiring as to whether the augers 13, 15 are indeed turning. Controller 35 shuts off motor 27 if augers 13, 15 are not turning as indicated by step 51. Step 53 will sense whether the motor temperature is excessive. If not, step 55 indicates that the tape speed, if any, is being sensed and a signal sent to controller 35 as indicated in step 57. Controller 35 makes a determination whether or not the tape is moving at all as indicated by step 58. If not, pump 25 will be rotated an increment in reverse to alleviate pressure at outlet 23, then motor 27 will be shut off, as indicated in step 60. Augers 13, 15 may continue rotating if the continuous mode has been selected for augers 13, 15. Also booster circuit 43 will be reset so that it will provide a maximum voltage upon the next pulse detection, as indicated in step 59.

Upon initial movement of applicator head 33 to dispense tape, booster circuit 43 will then apply a maximum voltage to the pump motor 27, as indicated in step 63. This causes pump motor 27 to rotate at a maximum RPM for a short increment of time to make sure that compound will be available at the applicator head 33 immediately when the tape starts to move. At the same time, step 61 indicates a proportional voltage will be supplied from signal conditioner 41 (FIG. 3) to motor 27. This voltage will be varied proportional to the tape speed being sensed to match the output of the compound with the feed of the tape.

Referring to FIGS. 4 and 5, one type of applicator 31 is shown. Applicator 31 has an elongated tubular body 65 that enables a worker to reach higher elevations from the floor. Body 65 has a head 33 on its distal end and a manifold 67 on its proximal end. A tape holder 69 is mounted to body 65 near its proximal end. Tape holder 69 is adapted to hold a roll of tape, which could be paper or fiberglass. The tape extends alongside body 65 to a feeder mechanism at head 31. The feeder mechanism includes a wheel 71, which in this embodiment has serrations on its edge for gripping a wall surface. Star wheel 71 has about the same width as the tape, for pressing the edges of the tape between the star wheel serrations and the wall surface. As the worker moves the head 33 downward while star wheel 71 is in contact with the wall surface, star wheel 71 will rotate and cause the tape to be fed from tape holder 69. Compound will be simultaneously dispensed through a slot in head 33 on the lower side of the tape.

Star wheel 71 is linked to a sprocket 73 by a chain 75, as shown in FIG. 4a. Rotation of star wheel 71 causes sprocket 73 to rotate. A sensor element 77 is rotated by movement of sprocket 73. In this embodiment, sensor element 77 comprises a right angle gear box that is located on the exterior of head 33 and connected to a cable 79 for rotating cable 79. Alternately, the gear drive element 77 could be located internally within body 65. Cable 79 extends alongside body 65 to tape speed sensor 37. Sensor 37 counts the rate of revolutions of cable 79 and encodes the count into digital pulses that it sends to controller 35 (FIG. 1). Sensor 37 may be a variety of types, including optical, inductive or Hall Effect proximity sensors. The length of cable 79 is selected to place sensor 37 a distance from head 33 that is adequate to avoid sensor 37 being immersed in water while head 33 is being cleaned. The distance, which is about 18 inches, avoids having to make sensor 37 waterproof. If head 33 is submersed in a cleaning bucket for a long period of time, it will not damage sensor 37, which will be located above the level of the water. However, preferably sensor 37 is water resistant so that water spray or scrubbing is acceptable.

Referring to FIG. 5a, the signal from sensor and encoder 37 is preferably transmitted by a signal wire 81, although RF transmission is also feasible. Signal wire 81 extends into the interior of tubular body 65 at a penetrator seal 83. The interior of body 65 will be filled with compound during use, however the presence of wire 81 within the interior will not affect delivery of the compound. because the compound is delivered by pump 25 (FIG. 1) rather than a piston. Signal wire 81 extends through the interior of body 65 to a point near the proximal end, where it exits at a penetrator seal 85, shown in FIG. 5a. Signal wire 81 then passes into manifold 67 and into the interior of an applicator portion of conduit 29. Conduit 29 is made up of at least two portions that are joined together by a coupling 86 that is located near manifold 67. Signal wire 81 extends from coupling 86 and has an electrical connector 87 for connecting with a controller portion of signal wire 81 that extends to controller 35 (FIG. 1). The controller portion of signal wire 81 extends through the interior of conduit 29 and exits the controller end of conduit 29, where it will be plugged into a receptacle on a unit that contains pump 25, motors 19, 27, controller 35 and compartment 11. Signal wire 81 thus provides a continuous connection from controller 35 (FIG. 1) to sensor and encoder 37 (FIG. 4a), with portions of the signal wire 81 being located within tubular body 65 and within conduit 29. Extending signal wire 81 through conduit 29 reduces the possibility of tangling.

The reason for extending a portion of sensor wire 81 within tubular body 65 is to bypass a movable sleeve 89, which is mounted to the exterior of tubular body 65. Sleeve 89 is reciprocated back and forth along the axis of tubular body 65 by the worker to sever the tape. An extension rod 91 extends forward from sleeve 89. A bracket 93 secured to the forward end of extension rod 91 connects a parallel and offset tube 95 to sleeve 89 for movement in unison. Tube 95 extends to the vicinity of head 33. A cutter chain 97 is enclosed within tube 95. Chain 97 has a cutter blade (not shown) mounted to it for making a transverse cut across the tape when sleeve 89 is replicated relative to body 65. Cutter chain 97 is biased by a coil spring 99 (FIG. 5b) secured within a tube 98 located on the opposite side from tube 95. Since there is only a small clearance between the inner diameter of sleeve 89 and the outer diameter of body 65, extending signal wire 81 within body 65 for at least the length of travel of sleeve 89 allows sleeve 89 to reciprocate without any effect on signal wire 81.

Applicator 31 optionally may have a kick out wheel 101 mounted to head 33. Kick out wheel 101 will pivot from a retracted storage position shown in FIG. 4a to an extended operation position in front of star wheel 71. Kick out wheel 101 has a sharp edge, rather than a wide blunt serrated periphery as star wheel 71. The sharp edge of kick out wheel 101 presses against tape to cause it to fold for applying tape to corners between wallboard.

Kick out wheel 101 is actuated by a cable 103 (FIG. 5b) that extends back to the proximal end of applicator 31. In this embodiment, cable 103 also extends within an interior portion of tubular body 65 for the length of the stroke of cutter sleeve 89. Cable 103 extends through the same penetrators 83 and 85 (FIGS. 5b and 5a) that also seal signal wire 81. The actuator for moving cable 103 forward and rearward to operate kick out tool 101 includes a pivotal link 105. Link 105 will pivot relative to body 65 and is located at the proximal end near manifold 67. Link 105 is mounted to a shaft or rotary member 107 that is shown in FIG. 7. A lever 109 is mounted pivotally to body 65 be means of a shaft or rotary member 111, both shafts 107 and 111 being free to rotate. Shaft 111 is larger in diameter than shaft 107, preferably twice the diameter. Lever 109 extends in a direction generally opposite that of link 105. A line, such as flexible cable 113, is wrapped at least partially around shaft 111 and also around shaft 107. Line 113 wraps around shaft 111 in one direction and around shaft 107 in the other direction. Consequently, pulling lever 109 in the direction indicated by the arrow will cause shaft 111 to rotate clockwise and shaft 107 to rotate counterclockwise. This causes link 105 to rotate clockwise to pull cable 103. Because of the difference in diameters between shafts 107 and 111, the travel of lever 109 is multiplied, causing lever 105 to rotate more than lever 111. A pair of gears of differing diameters would also perform the same function as shafts 107, 111 and line 113, with the teeth of the gears serving as an engaging member rather than line 113.

In the operation of applicator 31, the worker will place compound in compartment 11 (FIG. 1) and rotate augers 13, 15 to mix the compound, if necessary. Water may also be added at this point, preferably compartment 11 having one or more nozzles for spraying water into the compound if needed. The rotation of augers 13, 15 is preferably in a reverse direction for mixing, causing compound to flow from the central area near outlet 23 toward the opposite ends. Once the compound is properly mixed, the operator will reverse the direction of rotation of augers 13, 15 and manually turn on pump 25 if pump 25 and conduit 29 are empty. Force plates 21 will push compound out of outlet 23, prefeeding pump 25. Pump 25 will pump compound through conduit 29. Initially, the operator will recycle the compound flowing from applicator head 33 back into compartment 11 to fill conduit 29 and applicator 31. The operator then begins to dispense compound and tape on the wall surface. While in the manual mode, the worker can adjust the flow rate of the compound by a set of remote controls mounted to the proximal end of applicator 31.

For automatic operation, the user places head 33 in contact with the wall with tape from holder 69 (FIG. 4b) being lead through head 33 and pressed between star wheel 71 and the wall. The user then starts moving head 33 along the wall, causing star wheel 71 to rotate. The frictional engagement of the tape against the wall causes it to adhere to the wall and feed from holder 69. At the same time, sensor 37 will sense movement of the tape. This movement is sensed due to rotation of chain 75, sprocket 73, sensor element 77 and cable 79, as shown in FIG. 4a. The signals are transmitted over wire 81 to controller 35 (FIG. 1), which controls the speed of pump 25. During the initial movement, booster circuit 43 (FIG. 3) will apply maximum voltage to controller 42 of pump motor 27 to cause it to operate at a high speed, preferably its maximum speed, for a short duration. This provides delivery of compound instantly to the wall surface on the underside of the tape. Once the duration from booster circuit 43 has transpired, signal conditioner 41 will take over as it will be providing a voltage based on the actual tape speed from inception of the movement of head 33. Signal conditioner 41 will vary the speed of motor 25 depending on the pulse rate being received from encoder 39, this pulse rate being proportional to the rate of speed of star wheel 71.

At the end of a stroke, the operator stops moving applicator head 33 along the wall, causing the pulses from sensor 39 to disappear. Signal conditioner 41 preferably applies a voltage to motor controller 42 of pump motor 27 to cause pump 25 to rotate an increment in reverse to alleviate pressure at output 23 (FIG. 1). Then, controller 35 shuts off pump motor 27 and resets booster circuits 43. The operator cuts the tape by stroking sleeve 89. The operator manually advances the tape alongside star wheel 71 and repeats the process for another wallboard joint. For cleanup, the entire head 33 can be submersed without fear of damaging the electrical components of sensor 37, which will be above the point of submersion.

The invention has significant advantages. The automatic mode dispenses the proper amount of compound to the head at all times. This not only reduces the amount of skill required for tape and bedding operations, it also speeds up the operation. The booster signal reduces time lag between the initial movement of the tape and the dispensing of compound. The auger provides a positive prefeed pressure to the pump and serves as a mixing device.

While the invention has been shown in only one of its forms, it should be apparent to those skilled in the art, that it is not so limited but is susceptible to various changes without departing from the scope of the invention. As previously mentioned, the applicator could be a considerably different type, such as one using a blade rather than a wheel. The sensor could be mounted in direct contact with the paper, rather than sensing rotation of a cable rotated by a rotary member. The signal wire and the kick out cable could be routed over the exterior of the sleeve although it is not preferable. Also, other types of actuation for the cutter and for the kick out tool are possible. A microprocessor could be used in place of dedicated circuit boards. The flow rate could be varied by the use of valves, although the pump speed is preferred. Other types of pumps could be used, rather than a progressive cavity pump. Although not as desirable, the pressure source could be air pressure rather than a mechanical pump.

We claim:

1. A method of applying compound and tape to a wallboard, comprising:
(a) providing a compartment having a compartment outlet and containing compound, a pressure source in communication with the outlet, a conduit leading from the pressure source, and an applicator containing a quantity of tape and connected to the conduit;
(b) placing a head of the applicator and a leading edge of the tape in contact with a wallboard and moving the head of the applicator to cause tape to feed from the applicator and adhere to the wallboard;
(c) sensing a rate of movement of the tape as it feeds from the applicator;
(d) in response to sensing the rate of movement of the tape, causing the pressure source to flow compound through the conduit and out of the applicator while the tape is feeding from the applicator; and
(e) automatically controlling a rate of compound flowing from the applicator in response to the rate of movement of the tape.

2. The method according to claim 1, wherein the pressure source flows compound to the applicator only if the movement of the tape is sensed.

3. The method according to claim 1, wherein step (e) is performed by varying an output of the pressure source.

4. The method according to claim 3, wherein the pressure source comprises a pump driven by a variable speed motor, and step (e) comprises varying the speed of the variable speed motor in a linear relationship relative to the rate of movement of the tape.

5. The method according to claim 4, further comprising varying the linear relationship between the speed of the variable speed motor and the rate of movement of the tape.

6. The method according to claim 1, further comprising automatically stopping flow of compound from the applicator if the movement of the tape ceases.

7. A method of applying compound and tape to a wallboard, comprising:
(a) providing a compartment containing compound and having a compartment outlet, a pump in communication with the outlet, a conduit leading from the pump, and an applicator containing a quantity of tape and connected to the conduit;
(b) placing a head of the applicator and a leading edge of the tape in contact with a wallboard and moving the head of the applicator to cause tape to feed from the applicator and adhere to the wallboard;
(c) sensing a speed of the tape as it feeds from the applicator;
(d) turning on the pump in response to movement of the tape, causing compound to flow through the conduit and out of the applicator while the tape is feeding from the applicator; and
(e) automatically controlling a rate of the pump in response to the speed of the tape.

8. The method according to claim 7, wherein step (e) is performed by controlling the speed of the pump.

9. The method according to claim 7, wherein the pump is automatically shut off when movement of the tape ceases.

10. The method according to claim 7, wherein step (e) is performed by controlling the speed of the pump in a linear response to the speed of the tape.

11. The method according to claim 7, wherein the flow rate of the pump is increased to a selected rate for a selected time upon initial movement of the tape.

12. The method according to claim 7, wherein step (e) comprises controlling the speed of the pump in proportion to the tape speed, except at the commencement of tape movement, wherein the pump will automatically operate at a selected maximum speed for a selected duration.

13. The method according to claim 7, further comprising mounting an auger in the compartment, the auger having a downstream end adjacent the compartment outlet, and wherein step (d) further comprises:
rotating the auger in a first direction to induce flow of the compound out the compartment outlet and into the pump; and the method further comprises:
rotating the auger in a second direction to mix compound while the pump is shut off.

14. The method according to claim 7, wherein step (a) comprises providing a progressive cavity pump having a rotor, and the method further comprises:
rotating the rotor in a reverse direction for an increment when the pump is being shut off.

15. An apparatus for applying tape and compound to a wallboard, comprising:
a compartment for containing compound and having a compartment outlet;
a pressure source in communication with the outlet;
a flexible conduit leading from the pressure source;
an applicator having a flow channel connected to the conduit and a head having a tape pathway for feeding tape, wherein placing the head in contact with a wallboard and moving the head of the applicator causes tape to feed from the applicator and adhere to the wallboard as compound flows through the flow channel;
an electrical controller operatively connected with the pressure source for controlling the pressure source; and
a sensor mounted to the applicator for sensing a rate of movement of the tape as it feeds from the applicator and sending a signal to the controller, which automatically controls a rate of compound flowing from the applicator in response to the rate of movement of the tape.

16. The apparatus according to claim 15, wherein the pressure source is a variable speed pump, and the controller controls the rate of compound flowing from the applicator by varying the speed of the pump.

17. The apparatus according to claim 15, wherein the controller prevents the pressure source from flowing compound to the applicator if movement of the tape ceases.

18. The apparatus according to claim 15, wherein:
the pressure source is a variable speed pump; and
the controller controls the speed of the pump in a linear response to speed of the tape, except during an initial movement of the head, at which time the controller increases the speed of the pump above the linear response for a selected time.

19. The apparatus according to claim 15, wherein the sensor comprises a rotary member that is rotated by movement of the tape.

20. An apparatus for applying tape and compound to a wallboard, comprising:
a compartment for containing compound and having a compartment outlet;
an electrically driven pump in communication with the outlet;
a flexible conduit leading from the pump;
an applicator having a body with a tubular flow channel connected to the conduit and a head having a tape pathway for feeding tape, the head having a wheel mounted thereon that engages and advances the tape when the wheel is rolled along a wallboard, the flow channel having an outlet adjacent the wheel that dispenses compound being pumped through the conduit by the pump;
an electrical controller operatively connected with the pump for controlling a pump flow rate;
a rotary mechanism mounted to the head of the applicator that rotates in unison with the wheel;
a cable cooperatively engaged with the rotary mechanism for rotation in unison with the rotary mechanism; and
an electrical sensor mounted to the body at a selected distance from the head and connected to the cable for sending a signal to the controller proportional to the speed of rotation of the cable and thereby the movement of the tape as it feeds from the applicator, the controller automatically controlling the pump flow rate in response to the rate of movement of the tape.

21. The apparatus according to claim 20, further comprising an electrical wire extending from the sensor to the controller for transmitting the signals.

22. The apparatus according to claim 20, further comprising:
a sleeve reciprocally carried on the body of the applicator for actuating a tape cutting mechanism in the head: wherein
the sensor is mounted to an exterior portion of the body adjacent a first end of the sleeve; and the apparatus further comprises:
an electrical wire connected to the sensor and extending from the exterior portion into the flow channel of the body adjacent the first end of the sleeve, the wire passing through the flow channel and exiting from the flow channel adjacent a second end of the sleeve, the wire being electrically connected with the controller for sending the signals from the sensor to the controller.

23. The apparatus according to claim 20, wherein the controller controls the pump flow rate by varying the speed of the pump.

24. The apparatus according to claim 20, further comprising:
a kickout wheel pivotally mounted to the head for applying a crease to the tape while applying the tape to corners;
a link pivotally mounted to a proximal end of the body and connected to the kickout wheel by a cable for pivoting the kickout wheel;
a manually operable lever pivotally mounted to the body;
a link rotary member mounted to the link for pivotal movement in unison and a lever rotary member mounted to the lever for movement in unison, the lever rotary member having a larger diameter than the link rotary member; and
an engaging member cooperatively connected between the rotary members so that rotation of the lever rotary member in a clockwise direction by movement of the lever rotates the link rotary member in a counterclockwise direction to move the link, cable and kickout wheel.

25. In an apparatus for applying tape and compound to a wallboard, the apparatus having an elongated tubular body with an interior flow channel for receiving compound, a head having a tape pathway for feeding tape, the head having a wheel mounted thereon that engages and advances the tape when the wheel is rolled along a wallboard, the flow channel having an outlet adjacent the wheel that dispenses compound being pumped through the conduit by the pump, and a kickout wheel pivotally mounted to the head for applying a crease to the tape while applying the tape to corners, the improvement comprising:
a link pivotally mounted to a proximal end of the body and connected to the kickout wheel by a cable for pivoting the kickout wheel;
a manually operable lever pivotally mounted to the body;
a link rotary member mounted to the link for pivotal movement in unison and a lever rotary member mounted to the lever for movement in unison, the lever rotary member having a larger diameter than the link rotary member; and
an engaging member cooperatively connected between the rotary members so that rotation of the lever rotary member in a clockwise direction by movement of the lever rotates the link rotary member in a counterclockwise direction to move the link, cable and kickout wheel.

26. The apparatus according to claim 25 wherein the engaging member comprises a line wrapped at least partially around the link rotary member in one direction and at least partially around the lever rotary member in an opposite direction.
